(19) United States
(12) Patent Application Publication
(10) Pub. No.: US 2008/0102197 A1
(43) Pub. Date: May 1, 2008

(54) Art glass birdfeeder with melted-in-glass glow-in-dark fluorescence

(75) Inventors: David Wei Chen, Lewis Center, OH (US); Jingsheng Ren, Worthington, OH (US)

Correspondence Address: David Chen, 707 Radio Drive, Lewis Center, OH, 43035, US

(73) Assignee: David Wei Chen, Lewis Center, OH (US)

(21) Appl. No.: 11/796,459

(22) Filed: Apr. 27, 2007

Related U.S. Application Data
(60) Provisional application No. 60/854,325, filed on Oct. 26, 2006.

(51) Int. Cl. C03C 4/12

(52) U.S. Cl. 427/157

(57) ABSTRACT

A Glow-in-dark art glass birdfeeder with melted-in-glass fluorescence is made by applying the fluorescence powder on the glass surface, and then heating the glass inside a high temperature furnace to blend the fluorescence powder with the glass. As the result, the glow-in-dark fluorescence powder can be hidden under or become part of the art glass design patterns.

### BACKGROUND

This invention is about a glow-in-dark art glass birdfeeder with melted-in-glass glow-in-dark fluorescence.

The traditional fluorescence glass birdfeeder usually has the fluorescent powder or elements painted or glued inside the blown glass. The downside of this tradition method is that the fluorescence powder can easily fall off from the glass surface and get mixed with the bird foods or nectar liquid, which may harm the bird or hummingbirds.

### OBJECT OF THE INVENTION

The purpose of this invention is to design a new fluorescence birdfeeder that will overcome the defect of the traditional fluorescence glass birdfeeders.

### SUMMARY

The method that we use for this new invention is to apply the fluorescence powder on the glass surface and heat the glass inside the high temperature furnace in order to blend the fluorescence powder with the glass. At the same time, the fluorescence powder can be hidden under or become part of the art glass design patterns.

By using this method, the fluorescence powder will melt with the glass and never fall off or mix with the bird's foods or nectar liquid.

We can use this method on the different kind of glass products i.e.; birdfeeders, hummingbird feeders, oil lamps, etc.

### DETAILED DESCRIPTION

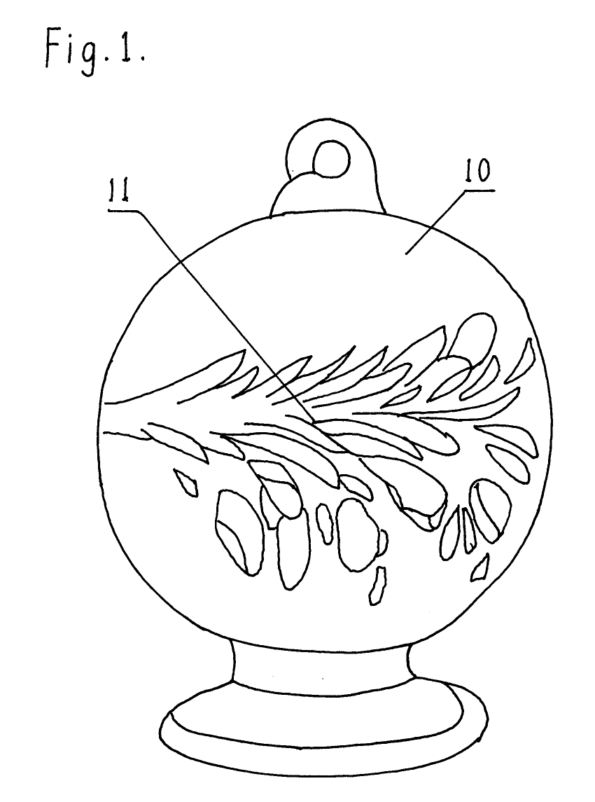

FIG. 1 (attached) shows a picture of a flower pattern on a glass birdfeeder that comes with fluorescence powders, and color elements, or design.

10—the birdfeeder glass.

11—The fluorescence powder blend in with art-glass elements.

Apply the ‘fluorescence powder—11’ on the surface of ‘the birdfeeder glass—10’ with art glass color elements; the glass will then be heated inside the furnace. This step will blend the fluorescence powder onto the glass with design pattern together or as part of design patter shown.

1. One kind of Glow-in-dark art glass birdfeeder with melted in glass fluorescence. It is unique process of apply the glow-in-dark fluorescence powder on inside surface of glass and than heating the glass inside a high temperature furnace to blend the fluorescence powder with the glass. As the result, glow-in-dark fluorescence powder can be hidden under or become part of the art glass design patterns.
